(19) United States
(12) Patent Application Publication
(10) Pub. No.: US 2019/0267782 A1
(43) Pub. Date: Aug. 29, 2019

(54) EXTERIOR AIR-PERMEABLE MEMBER

(71) Applicant: SUMITOMO WIRING SYSTEMS, LTD., Yokkaichi-shi, Mie (JP)

(72) Inventor: Takao KUSHIMA, Yokkaichi (JP)

(73) Assignee: SUMITOMO WIRING SYSTEMS, LTD., Yokkaichi-shi, Mie (JP)

(21) Appl. No.: 16/349,019

(22) PCT Filed: Oct. 23, 2017
(86) PCT No.: PCT/JP2017/038167

§ 371 Date: May 10, 2019

(30) Foreign Application Priority Data
Nov. 10, 2016 (JP) 2016-219511

(51) Int. Cl. H02G 3/04; B60R 16/02

(52) U.S. Cl. CPC H02G 3/0468; B60R 16/0215

(57) ABSTRACT

An exterior air-permeable member that includes a tube into which a wire can be inserted and in which a communicating hole is formed that is open to an outer-circumferential face of the tube; a body having an exterior fitted onto an outer periphery of the tube, and an attachment formed to be open to an outer periphery of the exterior and coming into communication with an inside of the tube via the communicating hole; an air-permeable film attached to the attachment; and a fixer that fixes the exterior to the tube.

This application is the U.S. National Phase of PCT/JP2017/038167 filed Oct. 23, 2017, which claims priority to JP 2016-219511 filed Nov. 10, 2016, the entire disclosure of which is incorporated herein by reference.

### BACKGROUND

The present disclosure relates to an exterior air-permeable member.

JP 2013-241143A discloses a cylindrical waterproof cover that is made of a rubber or an elastomer and is to be attached to a terminal of an exterior material that allows a high-voltage wire harness to pass therethrough in a sealing manner. An air-permeable film is attached to a peripheral wall of this waterproof cover, and air can flow in and out of the waterproof cover through the air-permeable film. This configuration adjusts the pressure within the waterproof cover, and prevents the waterproof cover from excessively bulging due to a drastic increase in the temperature.

### SUMMARY

The aforementioned waterproof cover is to be attached to a connector, and therefore the position of the air-permeable film is limited to a position within a region near the connector. For this reason, a problem arises in that there are large constraints on layout in terms of the arrangement of the air-permeable film.

An exemplary aspect of the disclosure reduces the constraints on layout in terms of the arrangement of the air-permeable film.

An exemplary aspect of the present disclosure includes an exterior air-permeable member with a tube into which a wire can be inserted and in which a communicating hole is formed that is open to an outer-circumferential face of the tube; a body having an exterior fitted onto an outer periphery of the tube, and an attachment formed to be open to an outer periphery of the exterior and coming into communication with an inside of the tube via the communicating hole; an air-permeable film attached to the attachment; and a fixer that fixes the exterior to the tube.

According to this configuration, the position of the air-permeable film on the tube in the axial direction can be set in any manner by appropriately changing the position of the communicating hole formed in the tube. Accordingly, according to the disclosure of the present application, constraints on layouts in terms of the arrangement of the air-permeable film can be reduced.

### BRIEF DESCRIPTION OF THE DRAWINGS

FIG. 1 is a plan view of an exterior air-permeable member according to Embodiment 1.

FIG. 2 is a side view of the exterior air-permeable member.

FIG. 3 is a cross-sectional view taken along a line X-X in FIG. 1.

FIG. 4 is a cross-sectional view taken along a line Y-Y in FIG. 1.

FIG. 5 is a side view showing a usage mode of the exterior air-permeable member, simplifying the shape of a corrugated tube and a holding member.

### DETAILED DESCRIPTION OF EMBODIMENTS

According to the present disclosure, the exterior may be fitted onto the tube over a region in a circumferential direction, the region being at least larger than or equal to a half circumference of the tube. According to this configuration, in a state before the body is fixed to the tube with the fixer, the body can be temporarily held relative to the tube.

According to an aspect of the present disclosure, the exterior may be made of an elastic material and able to undergo elastic deformation so as to separate from the outer periphery of the tube. According to this configuration, the body can be attached to the tube so as to approach the tube in a radial direction by deforming the exterior in an expanding manner.

The present disclosure may further include a protrusion that is cylindrical, is formed in the body, protrudes toward an inner peripheral side from the attachment, and is accommodated in the tube from the communicating hole. According to this configuration, in a state before the body is fixed to the tube with the fixer, the body can be positioned such that the attachment corresponds to the communicating hole by accommodating the protrusion in the communicating hole.

The present disclosure may further include a stopper protrusion that is formed in an outer periphery of the protrusion, and is locked to a hole-edge of the communicating hole in an inner periphery of the tube. According to this configuration, in a state before the body is fixed to the tube with the fixer, the body can be temporarily held relative to the tube by locking the stopper protrusion to the hole-edge of the communicating hole.

### Embodiment 1

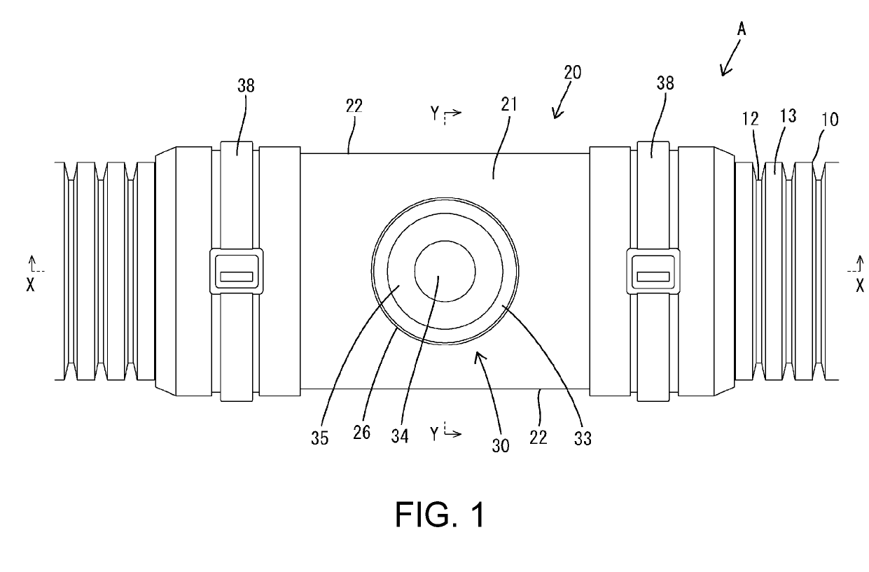

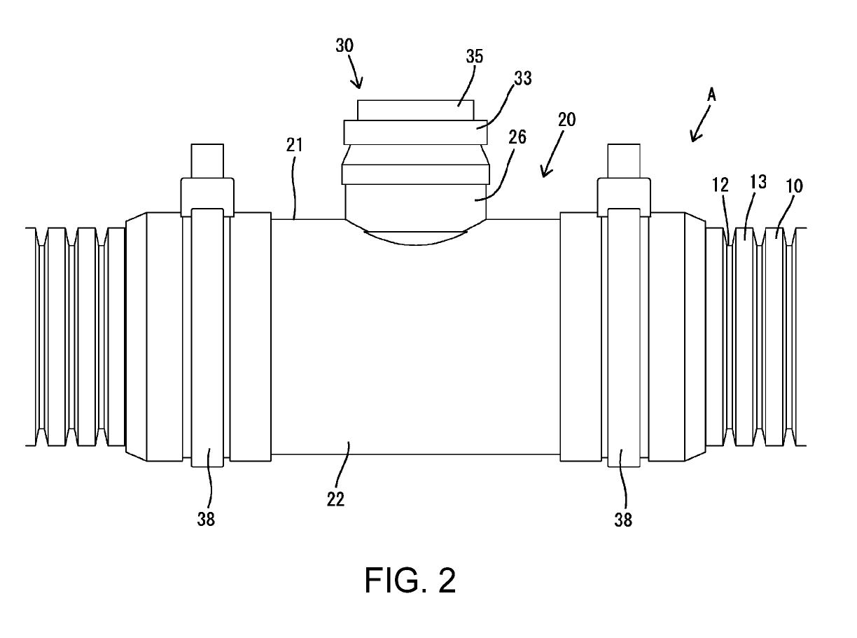

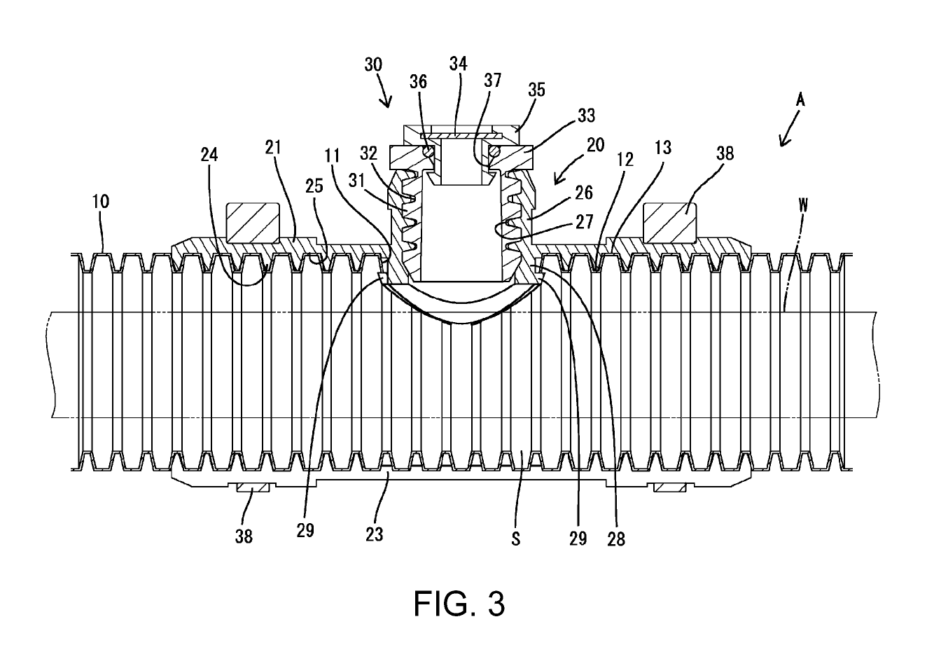

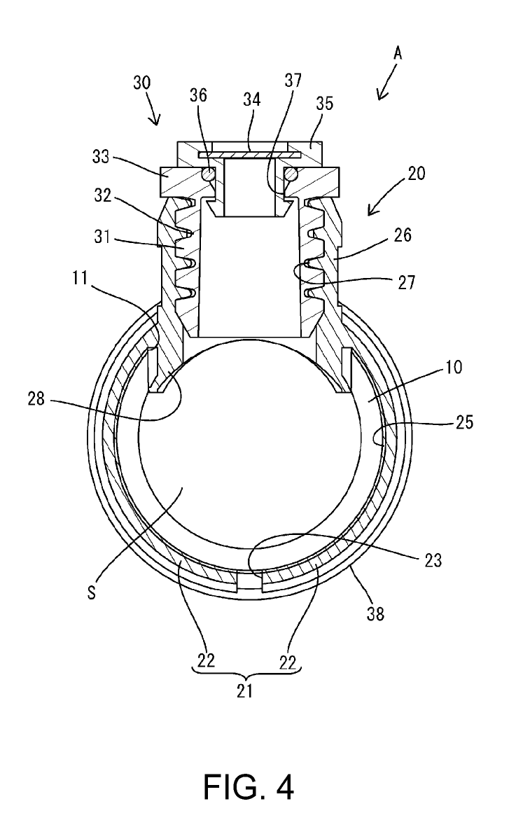

Embodiment 1 of the present disclosure will be described below with reference to FIGS. 1 to 5. In the following description, the upward direction and the downward direction are defined as those shown in FIGS. 2 to 4. The leftward direction and the rightward direction are defined as those shown in FIGS. 1 to 3.

An exterior air-permeable member A in this embodiment includes a corrugated tube 10 (a tubular member/tube) that is made of a synthetic resin, a holding member 20 (body) that has rubber elasticity and is made of an elastomer or the like, an air-permeable film unit 30, and a pair of tie bands 38 (a fixing member/fixer) for fixing the holding member 20 to the corrugated tube 10.

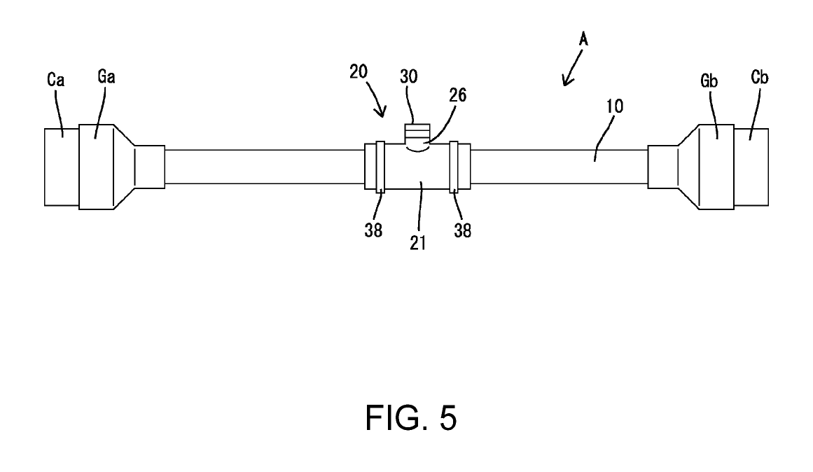

The corrugated tube 10 has a tubular shape with a circular cross-sectional shape. The corrugated tube 10 has a bellows shape over the entire length thereof, and thus can undergo elastic deformation such that the axis thereof curves. High-voltage wires W, which may be used in an electric vehicle or a hybrid vehicle, are inserted in the corrugated tube 10. As shown in FIG. 5, connectors Ca and Cb, which are provided on an inverter, a batter, a motor or the like, for example, are connected to both end portions of the wires W. Small-diameter end portions of grommets Ga and Gb, which are made of an elastomer and have rubber elasticity, are fitted onto respective end portions of the corrugated tube 10 in an airtight manner. Large-diameter end portions of the grommets Ga and Gb are fitted onto the connectors Ca and Cb, respectively, in an airtight manner. Thus, a sealed space S surrounded by the corrugated tube 10 and the grommets Ga and Gb is formed between the pair of connectors Ca and Cb, and the wires W are accommodated in this sealed space S.

A communicating hole 11 for bringing the outside and the inside of the corrugated tube 10 into communication is formed in the outer periphery of the corrugated tube 10. The position on the corrugated tube 10 in the axial direction at which the communicating hole 11 is formed is set to the same position as the position at which a later-described air-permeable film 34 is to be arranged. The communicating hole 11 can be formed at any position on the corrugated tube 10 in the axial direction, and can also be formed at any position on the corrugated tube 10 in the circumferential direction. A plurality of recessed portions 12, which extend in the circumferential direction, and a plurality of protruding portions 13, which also extend in the circumferential direction, are alternately arranged in the axial direction in the outer periphery of the corrugated tube 10.

The holding member 20 is a single member that includes an exterior portion 21 (exterior), an attachment portion 26 (attachment), and a positioning portion 28 (protrusion). The exterior portion 21 is constituted by a pair of front and rear arc-shaped plate portions 22, each forming a substantially semicircular arc shape, and forms a substantially cylindrical shape that surrounds the outer periphery of the corrugated tube 10 over the entire circumference thereof. A slit 23, which extends in the axial direction, is formed in the exterior portion 21 over the entire length thereof, and the pair of arc-shaped plate portions 22 can undergo elastic deformation so as to separate from the outer-circumferential face of the corrugated tube 10 while expanding the opening width of the slit 23. Ribs 24, which are to be fitted to the recessed portions 12 in the outer periphery of the corrugated tube 10, and groove portions 25, which are to be fitted to the protruding portions 13 in the outer periphery of the corrugated tube 10, are formed in the inner periphery of the exterior portion 21.

The attachment portion 26 protrudes radially outward from the outer periphery of the exterior portion 21 to form a cylindrical shape. The attachment portion 26 is arranged in the center portion of the exterior portion 21 in the axial direction, and is arranged at a boundary portion of the pair of arc-shaped plate portions 22 in the circumferential direction of the exterior portion 21. A plurality of locking protrusions 27, which extend in the circumferential direction, are formed in the inner periphery of the attachment portion 26 with gaps therebetween in the axial direction thereof. The positioning portion 28 protrudes to form a ring shape radially inward from the inner periphery of the exterior portion 21. The positioning portion 28 is arranged coaxially with the attachment portion 26. The outside diameter of the positioning portion 28 is the same as or slightly smaller than the inside diameter of the communicating hole 11 in the corrugated tube 10. A stopper protrusion 29 is formed in the outer periphery of the positioning portion 28.

The air-permeable film unit 30 is a single member formed by integrating a tubular member 31, which is made of synthetic resin and is more rigid than the holding member 20, with the air-permeable film 34. A plurality of locking grooves 32, which extend in the circumferential direction, are formed in the outer periphery of the tubular member 31 with gaps therebetween in the axial direction thereof. An increased-diameter portion 33 is formed in the outer periphery of a leading end portion of the tubular member 31. The air-permeable film 34 has characteristics that air (gas) can pass therethrough but a liquid and a solid cannot pass therethrough. The air-permeable film 34 is integrated with a cap 35 by means of mold forming, for example. The cap 35 is attached to the leading end portion of the tubular member 31 through a seal ring 36, and closes an opening portion 37 at the leading end portion of the tubular member 31 in an airtight manner.

The air-permeable film unit 30 is attached to the holding member 20 by fitting the tubular member 31, from a base end side thereof, into the attachment portion 26. Upon the air-permeable film unit 30 being attached to the holding member 20, the plurality of locking grooves 32 in the outer periphery of the tubular member 31 are locked to the plurality of locking protrusions 27 in the inner periphery of the attachment portion 26 in a tightly fitted state. Due to this locking, the air-permeable film unit 30 is kept in a state of being attached to the holding member 20, and gaps between the inner periphery of the attachment portion 26 and the outer periphery of the tubular member 31 are kept in an airtight state.

The holding member 20 to which the air-permeable film unit 30 has been attached is attached so as to cover the communicating hole 11 and a region therearound in the outer periphery of the corrugated tube 10. When the holding member 20 is attached, the pair of arc-shaped plate portions 22 are elastically deformed so as to be expanded, thus the slit 23 is expanded greatly, and the thus-expanded arc-shaped plate portions 22 are put over the outer periphery of the corrugated tube 10. At this time, the positioning portion 28 is inserted into the communicating hole 11. As a result of this insertion, the holding member 20 is positioned relative to the corrugated tube 10 in the axial direction and the circumferential direction. Also, the ribs 24 in the inner periphery of the exterior portion 21 are fitted to the recessed portions 12 in the outer periphery of the corrugated tube 10, the groove portions 25 in the inner periphery of the exterior portion 21 are fitted to the protruding portions 13 in the outer periphery 13 of the corrugated tube 10, and thus, the holding member 20 is positioned relative to the corrugated tube 10 in the axial direction.

Furthermore, the stopper protrusion 29 is locked to a hole-edge portion (hole-edge) of the communicating hole 11 in the inner periphery of the corrugated tube 10. Due to this locking, the holding member 20 is restricted from withdrawing in the radial direction from the corrugated tube 10. Also, upon the holding member 20 being attached to the corrugated tube 10, the pair of arc-shaped plate portions 22 are elastically restored to the substantially semicircular arc shape, and the exterior portion 21 is restored to the substantially cylindrical shape. As a result of this elastic restoration of the arc-shaped plate portions 22, the exterior portion 21 surrounds the corrugated tube 10 so as to come into intimate contact therewith over the entire circumference thereof. As a result of the exterior portion 21 thus surrounding the corrugated tube 10, the holding member 20 enters a state of being restricted from withdrawing from the corrugated tube 10 in the radial direction.

After the holding member 20 is attached to the corrugated tube 10, the two tie bands 38 are wound around the outer periphery of the exterior portion 21 and are fastened. The tie bands 38 are synthetic resin members with a known structure that cannot be loosened after being fastened once. The positions at which the tie bands 38 are wound are two positions that are separate from each other in the axial direction of the corrugated tube 10 with the attachment portion 26 therebetween. By fastening the tie bands 38, the exterior portion 21 comes into intimate contact, in an airtight manner, with the outer periphery of the corrugated tube 10 in a region surrounding the communicating hole 11. Thus, an air flow through gaps between the outer peripheries of the connectors Ca and Cb and the inner periphery of the exterior portion 21 and the communicating hole 11 serving as air passages is blocked between the sealed space S in the corrugated tube 10 and the outside of the corrugated tube 10, and the holding member 20 is reliably prevented from withdrawing from the corrugated tube 10. The assembly of the exterior air-permeable member A is completed as described above.

If the air pressure within the sealed space S drastically increases due to a temperature change or the like, there is a concern that the grommets Ga and Gb, which have rubber elasticity, will undergo elastic deformation in a bulging manner and interfere with members therearound. However, with the exterior air-permeable member A according to this embodiment, the air in the sealed space S (i.e. in the corrugated tube 10) flows out of the corrugated tube 10 through the communicating hole 11, the tubular member 31, and the air-permeable film 34, and the air pressure within the sealed space S is kept at a pressure that is substantially the same as the atmospheric pressure. Accordingly, there is no concern that the grommets Ga and Gb will bulge excessively. If the air pressure within the sealed space S decreases, the air outside of the corrugated tube 10 flows into the sealed space S through a reverse route, and in this case as well, the air pressure within the sealed space S is kept at a pressure that is substantially the same as the atmospheric pressure.

The exterior air-permeable member A according to this embodiment includes the corrugated tube 10, the holding member 20, the air-permeable film 34, and the tie bands 38. The corrugated tube 10 allows the wires W to pass therethrough, and the communicating hole 11 is open in the outer-circumferential face of the corrugated tube 10. The holding member 20 includes the exterior portion 21, which is fitted onto the outer periphery of the corrugated tube 10, and the attachment portion 26, which is open in the outer periphery of the exterior portion 21. The attachment portion 26 is in communication with the inside (sealed space 5) of the corrugated tube 10 through the communicating hole 11, and the air-permeable film 34 is attached to the attachment portion 26. The exterior portion 21 is fixed to the outer periphery of the corrugated tube 10 with the tie bands 38.

According to this configuration, the position of the air-permeable film 34 in the axial direction of the corrugated tube 10 and the position of the air-permeable film 34 in the circumferential direction of the corrugated tube 10 can be set in any manner by appropriately changing the position of the communicating hole 11, which is formed in the corrugated tube 10, in the axial direction and the position of the communicating hole 11 in the circumferential direction. Also, the direction of the air-permeable film 34 can be set in any manner by changing the shape of the attachment portion 26 and the position at which the air-permeable film 34 is attached. Accordingly, with the exterior air-permeable member A according to this embodiment, constraints on layout in terms of the arrangement of the air-permeable film 34 can be reduced.

The exterior portion 21 is fitted onto the corrugated tube 10 over a region in the circumferential direction that is at least larger than or equal to the half circumference (substantially the entire circumference) thereof. Accordingly, in a state before the tie bands 38 fix the exterior portion 21 (holding member 20) to the corrugated tube 10, the holding member 20 can be temporarily held relative to the corrugated tube 10.

The exterior portion 21 is made of an elastic material (elastomer, rubber etc.), and can undergo elastic deformation so as to separate from the outer periphery of the corrugated tube 10. By thus deforming the exterior portion 21 in an expanding manner, the holding member 20 can be attached to the corrugated tube 10 so as to approach the corrugated tube 10 in the radial direction. Accordingly, a good operability is achieved when the holding member 20 is attached to the corrugated tube 10 compared with the case of fitting the exterior portion 21 (holding member 20) onto one end portion of the corrugated tube 10 and thereafter sliding the exterior portion 21 in the axial direction.

The holding member 20 has the tubular positioning portion 28 that protrudes toward the inner peripheral side from the attachment portion 26 and is accommodated in the corrugated tube 10 from the communicating hole 11. According to this configuration, in a state before the holding member 20 is fixed to the corrugated tube 10 with the tie bands 38, the holding member 20 can be positioned such that the attachment portion 26 corresponds to the communicating hole 11 by internally fitting the positioning portion 28 to the communicating hole 11. Furthermore, the stopper protrusion 29, which is to be locked to the hole-edge portion of the communicating hole 11 in the inner periphery of the corrugated tube 10, is formed on the outer periphery of the positioning portion 28. According to this configuration, in a state before the holding member 20 is fixed to the corrugated tube 10 with the tie bands 38, the holding member 20 can be temporarily held reliably relative to the corrugated tube 10 by locking the stopper protrusion 29 to the hole-edge portion of the communicating hole 11.

### OTHER EMBODIMENTS

The present disclosure is not limited to the embodiment that has been described in the above description and drawings, and for example, the following embodiments are also included in the technical scope of the present disclosure.

(1) In the above embodiment, the exterior portion can undergo elastic deformation in an expanding manner so as to separate from the outer periphery of the tubular member. However, a configuration may alternatively be employed in which the exterior portion is continuous over the entire circumference and does not undergo elastic deformation in an expanding manner. In this case, a configuration may be employed in which the positioning portion is not formed on the inner circumference of the exterior portion, and the holding member is attached by being slid in the axial direction from an end portion of the tubular member.

(2) In the above embodiment, the exterior portion is fitted onto the tubular member over a region in the circumferential direction that is at least larger than or equal to the half circumference thereof. However, the exterior portion may alternatively be fitted onto the tubular member only in a region in the circumferential direction that is smaller than the half circumference thereof.

(3) In the above embodiment, the exterior portion is made of an elastic material, but the exterior portion may alternatively be made of a material that is unlikely to undergo elastic deformation. In this case, a configuration may be employed in which the positioning portion is not formed on the inner periphery of the exterior portion, and the holding member is attached by being slid in the axial direction from an end portion of the tubular member, or the covering area of the exterior portion in the circumferential direction is smaller than the half circumference.

(4) In the above embodiment, the fixing member is a tie band that is made of a synthetic resin and cannot be loosened after being fastened once, but the fixing member may alternatively be a member that can be loosened even after being fastened, an adhesive, an adhesive tape, or the like.

(5) In the above embodiment, the stopper protrusion is formed in the positioning portion, but the positioning portion does not need to have a stopper protrusion.

(6) In the above embodiment, the positioning portion is formed in the holding member, but the holding member does not need to have a positioning portion.

(7) In the above embodiment, the air-permeable film is attached to the holding member via the tubular member, but the air-permeable film may alternatively be directly attached to and integrated with the holding member by means of insert molding or the like.

(8) In the above embodiment, the tubular member is a corrugated tube, but the tubular member is not limited to a corrugated tube and may alternatively be a shield pipe or the like.

1. An exterior air-permeable member comprising:
a tube into which a wire can be inserted and in which a communicating hole is formed that is open to an outer-circumferential face of the tube;
a body having an exterior portion fitted onto an outer periphery of the tube, and an attachment formed to be open to an outer periphery of the exterior and coming into communication with an inside of the tube via the communicating hole;
an air-permeable film attached to the attachment; and
a fixer that fixes the exterior portion to the tubular tube.

2. The exterior air-permeable member according to claim 1,
wherein the exterior is fitted onto the tube over a region in a circumferential direction, the region being at least larger than or equal to a half circumference of the tube.

3. The exterior air-permeable member according to claim 1,
wherein the exterior is made of an elastic material and can undergo elastic deformation so as to separate from the outer periphery of the tube.

4. The exterior air-permeable member according to claim 1, further comprising:
a protrusion that is cylindrical, is formed in the body, protrudes toward an inner peripheral side from the attachment, and is accommodated in the tube from the communicating hole.

5. The exterior air-permeable member according to claim 4, further comprising:
a stopper protrusion that is formed in an outer periphery of the protrusion, and is locked to a hole-edge of the communicating hole in an inner periphery of the tube.
